(19) United States
(12) Patent Application Publication
(10) Pub. No.: US 2025/0067373 A1
(43) Pub. Date: Feb. 27, 2025

(54) Methodology to Enable the Use of Oxide Dispersion Strengthened Alloys and Precipitation Strengthen Nickel-Based Alloys for Advanced Energy Systems

(71) Applicant: Electric Power Research Institute, Inc., Palo Alto, CA (US)

(72) Inventors: David Wayne Gandy, Clinton, NC (US); Mark Albert, Charlotte, NC (US)

(21) Appl. No.: 18/727,060

(22) PCT Filed: Jan. 6, 2023
(86) PCT No.: PCT/US2023/010288

§ 371 Date: Jul. 5, 2024

Related U.S. Application Data
(60) Provisional application No. 63/297,348, filed on Jan. 7, 2022.

(51) Int. Cl. F16L 23/024; B22F 5/10; B22F 10/25; B22F 10/28; B33Y 10/00; B33Y 70/00; B33Y 80/00

(52) U.S. Cl. CPC F16L 23/024; B22F 5/106; B22F 10/25; B22F 10/28; B22F 2301/15; B33Y 10/00; B33Y 70/00; B33Y 80/00

(57) ABSTRACT

The present invention is directed to methods for constructing a flange on a pipe using an additive manufacturing process, such as directed energy deposition, powder bed fusion, friction-stir, or diode laser cladding. The flange can be constructed on a pipe comprising an oxide dispersion strengthen or nickel-based alloys, in particular a precipitation strengthened nickel-based alloy, such that the pipe maintains its inherent mechanical and metallurgical properties, including hardness, tensile strength, yield strength, fracture toughness, creep strength, fatigue, which would otherwise be reduced based upon typical welding of a flange to the end of the pipe. The flange can be constructed around the exterior of a pipe at the end of the pipe to allow use of the flange in connecting the pipe via bolting to other piping components, such as another pipe with a corresponding flange, a valve flange, a pump flange, or any other type of flange.

### BACKGROUND OF THE INVENTION

### Field of the Invention

The invention, including its various embodiments, relates to methods for building a flange on the outer surface of a pipe for connection to another pipe and flange using an additive manufacturing process. In particular, the invention, including its various embodiments, relates to methods for building a flange on the outer surface of an oxide dispersion strengthen alloy pipe or a precipitation strengthen nickel-based alloy pipe using additive manufacturing for connection to another pipe flange, a valve flange, a pump flange, or any other type of flange.

### Description of Related Art

Oxide dispersion strengthened alloys (“ODS” alloys) were developed over 50 years ago for high temperature service applications. These alloys offer superior corrosion resistance in oxidizing, oxidizing/sulphidizing, and oxidizing/chlorinating environments. While ODS alloys have been proven to demonstrate incredible strength properties at very high temperatures (<1100° C., 2012° F.), they have proven almost impossible to join using conventional joining/welding techniques.

Conventional pipe-to-pipe joining techniques include welding methodologies to weld pipe sections together. However, when such welding methodologies are applied to pipe having ODS alloys a disruption of the distribution of oxides within the metal matrix occurs resulting in a significant reduction in strength and toughness of the ODS alloy—the reduction along the hoop direction of the component (e.g., pipe, header, etc.) is of particular concern for the component integrity.

Instead of welding pipe-to-pipe, another way to join piping components is through the use of flanges that are welded directly onto the end of a pipe. However, such methodologies result in a change in the microstructure of the component, for example, at the end of the pipe where the flange is attached. In the case of a pipe, the microstructure change may occur through the entire thickness of the pipe, from the inside to the outside of the pipe, due to welding. As a result, the mechanical properties of the pipe, including hardness, tensile strength, yield strength, fracture toughness, creep strength, and fatigue will be reduced across the throughwall, thereby considerably reducing the strength along the hoop direction of the pipe. Accordingly, when welding methodologies are used to attach a flange to an ODS alloy pipe, a similar disruption of the distribution of oxides within the metal matrix results in a significant reduction in strength and toughness of the ODS alloy, particularly along the hoop direction of the component (e.g., pipe, header, etc.).

Similarly, joining of precipitation strengthened nickel-based alloys also results in the degradation of properties particularly along the hoop direction of the component. Accordingly, with respect to piping components constructed using precipitation strengthened nickel-based alloys, conventional welding is not advised.

Accordingly, there is a need for improved joining methods for joining various piping components. In particular, there is a need for improved joining methods for joining various ODS piping components, such as ODS pipes, that maintain the various mechanical properties of the ODS alloy material and avoid or minimize any loss of strength of the ODS component. Further, improved joining methods for joining nickel-based alloys, in particular, precipitation strengthened nickel-based alloys such as pipes constructed from precipitation strengthened nickel-based alloys, that similarly avoid or minimize any loss of strength of the nickel-based alloy component are needed.

### BRIEF SUMMARY OF THE INVENTION

In general, the present invention is directed to methods for constructing a flange on a pipe using an additive manufacturing process. In some embodiments, the flange can be constructed using such as directed energy deposition, powder bed fusion, friction-stir, or diode laser cladding additive manufacturing processes or a combination of these. The flange can be constructed around the exterior of a pipe at the end of the pipe to allow use of the flange in connecting the pipe via bolting to other piping components, such as another pipe with a corresponding flange, a valve flange, a pump flange, or any other type of flange. It should be appreciated that the present invention can also be used to construct a flange on other piping components or equipment, such as on a valve, pump, heat exchanger and other similar components. It should be appreciated that the present invention may be used to construct a flange on a component, such as a piping component, that is constructed of an oxide dispersion strengthen (“ODS”) or nickel-based alloy, in particular, a precipitation strengthened nickel-based alloy. By using additive manufacturing, the mechanical and metallurgical properties of the ODS or nickel-based alloy material can be retained after constructing the flange on the pipe such that the properties of the pipe (including its hoop strength) are not degraded at key stress regions. The use of a flange deposited around the outer diameter of the pipe described herein provides a methodology to avoid property degradation in ODS and nickel-based alloys and, in particular, in precipitation strengthened nickel-based alloys.

In one embodiment, the flange is constructed on a pipe comprising an oxide dispersion strengthen (“ODS”) or nickel-based alloy. In this particular embodiment, the additive manufacturing process used to construct the flange on the pipe maintains the inherent properties of the pipe ODS or nickel-based alloy. In other words, certain material properties of the ODS alloy or nickel-based alloy can be retained after constructing the flange on the pipe due to the use of an additive manufacturing process, such as directed energy deposition, powder bed fusion, friction-stir, or diode laser cladding. In this manner, the mechanical and metallurgical properties, including strength and toughness properties (e.g., hoop strength), of the pipe are not degraded at key stress regions as compared to welding a flange on the end of a pipe. Thus, the present invention provides for the full use of ODS or nickel-based alloys in piping applications, particularly in high temperature applications. The additive manufacturing processes produce very little dilution and heat transfer into the substrate pipe, thus producing minimal or no microstructural changes to the substrate pipe alloy. In other words, compared to conventional welding of a flange onto the end of a pipe and disruption of the microstructure at the end of the pipe where the flange is attached, the additive manufacturing process deposits the material from which the flange is constructed on the outside surface of the pipe at one end of the pipe and thereby avoids or minimizes disruption of the microstructure of the pipe, which, in turn, allows the pipe to retain its mechanical properties and strength.

In one embodiment, the present invention provides a method for constructing a flange on a pipe, comprising using an additive manufacturing process to build a flange on an outer surface of a pipe at a first end of the pipe. In another embodiment, the method uses a pipe comprising an oxide dispersion strengthen or nickel-based alloy that retains certain mechanical and metallurgical properties after fabrication of the flange on the pipe, which allows for the use of such pipe alloys in various piping applications.

In another embodiment, the present invention provides a pipe and flange comprising a pipe having a first end comprising an exposed cross-sectional surface and an outer cylindrical surface and a flange attached to the pipe on the outer cylindrical surface at the first end such that the cross-sectional surface of the pipe is exposed, wherein the flange comprises an additive manufactured flange.

### BRIEF DESCRIPTION OF THE SEVERAL VIEWS OF THE DRAWINGS

FIG. 1 is a perspective view of a flange according to one embodiment of the present invention;

FIG. 2 is a perspective view of the flange of FIG. 1 on a section of a pipe according to one embodiment of the present invention;

FIG. 3A is an elevational view of the longitudinal side of the flange and pipe of FIG. 2 according to one embodiment of the present invention;

FIG. 3B is an elevational view of the longitudinal side of a flange and a pipe according to one embodiment of the present invention;

FIG. 4 is an elevational view of the end or cross-section of the flange and pipe of FIG. 2 according to one embodiment of the present invention;

FIG. 5A illustrates a longitudinal cross section of a pipe and flange welded to the pipe and the associated welding regions;

FIG. 5B illustrates a longitudinal cross-section of a pipe and flange attached to the pipe according to methods of the present invention; and

FIG. 6 is an elevational view of the end or cross-section of a flange according to one embodiment of the present invention.

### DETAILED DESCRIPTION OF THE INVENTION

The present invention is more fully described below with reference to the accompanying drawings. While the present invention will be described in conjunction with various embodiments, such should be viewed as examples and should not be viewed as limiting or as setting forth the only embodiments of the invention. Rather, the present invention includes various embodiments or forms, various related aspects or features, and various uses, as well as alternatives, modifications, and equivalents to the foregoing, all of which are included within the spirit and scope of the invention and the claims, whether or not expressly described herein. Further, the use of the terms “invention,” “present invention,” “embodiment,” and similar terms throughout this description are used broadly and are not intended to mean that the invention requires, or is limited to, any particular embodiment or aspect being described or that such description is the only manner in which the invention may be made or used.

In general, the present invention is directed to methods for joining various piping components and related equipment. In particular, the present invention is directed to methods for joining various piping components and related equipment that are made from high temperature alloys, such as an oxide dispersion strengthen (“ODS”) alloy or from nickel-based alloys, in particular, precipitation strengthened nickel-based alloys. The methods of the present invention provide the ability to join such high temperature alloy components while avoiding or minimizing any reduction in mechanical properties, such as hardness, tensile strength, yield strength, fracture toughness, creep strength, and fatigue, of the high temperature alloy components, thereby retaining their strength and usefulness in high temperature applications. By using additive manufacturing, the mechanical and metallurgical properties of the ODS or nickel-based alloy material can be retained after constructing the flange on the pipe such that the properties of the pipe (including its hoop strength) are not degraded at key stress regions.

In contrast to traditional pipe-to-pipe or flange welding techniques, the present invention provides methods for joining high temperature alloy components, such as ODS or nickel-based alloy pipes, by constructing a flange on the pipe using an additive manufacturing process. In some embodiments, the flange can be constructed using various additive manufacturing processes, such as directed energy deposition or powder bed fusion additive manufacturing processes or a combination of the two. Another additive manufacturing process that may be used is friction-stir additive manufacturing. The flange can be constructed around the exterior of a pipe at the end of the pipe to allow use of the flange in connecting the pipe via bolting to other piping components, such as another pipe with a corresponding flange, a valve flange, a pump flange, or any other type of flange. Accordingly, it should be appreciated that the present invention can also be used to construct a flange on other piping components or equipment, such as on a valve, pump, heat exchanger and other similar components

In particular, the additive manufacturing process used to construct the flange on the pipe maintains the inherent properties of the pipe ODS alloy or nickel-based alloy. In other words, certain material properties of the ODS alloy or nickel-based alloy can be retained after constructing the flange on the pipe using an additive manufacturing process, such as directed energy deposition or powder bed fusion. In this manner, the mechanical and metallurgical properties of the pipe, such as hardness, tensile strength, yield strength, fracture toughness, creep strength, and fatigue, and microstructure are not degraded throughout the pipe thickness and particularly at key stress regions resulting in retention of the strength of the ODS or nickel-based alloys, particularly along the hoop direction. In particular, the magnitude of penetration into the pipe by the additive manufacturing material used to construct the flange can be minimized, which allows for the mechanical and metallurgical properties of the pipe to remain substantively or fully retained. Accordingly, such mechanical and metallurgical properties of the pipe (e.g., hoop strength) are not degraded compared to conventional welding methods used to attach a flange to the end of a pipe. As a result of retaining such strength, joining ODS or nickel-based alloy components, such as pipes, in this manner provides for the use of these joined components in high temperature piping applications.

Following, various embodiments of flange constructed using the methods of the present invention are described in connection with the Figures. In addition, the methods for constructing the flange on the corresponding pipe are also described.

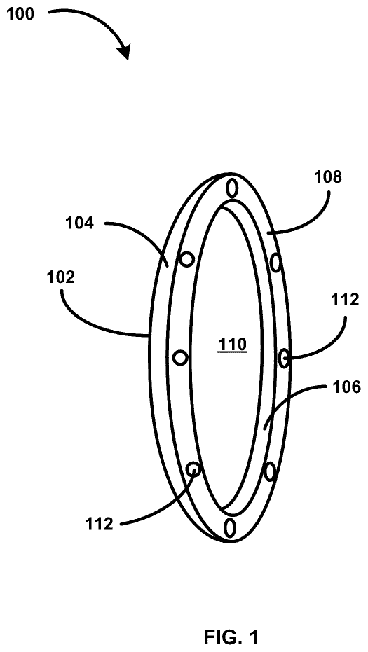

FIG. 1 is a perspective view of a flange according to one embodiment of the present invention. The flange 100 includes a body 102. In some embodiments, the body 102 is a single body constructed on the exterior of a pipe section, such as the end of a pipe using an additive manufacturing process, such as directed energy deposition or powder bed fusion additive manufacturing processes or a combination of the two. The body 102 has the shape of an open cylinder and has an exterior surface 104 and an interior surface 106. It should be appreciated that the interior surface 106 would be adjacent to and connected to the exterior surface of the corresponding pipe upon which the flange 100 is constructed. The body 102 also has a front face or end 108 and a corresponding rear face opposite the front face 108 (not shown). The body 102, as an open cylinder, provides a circular opening 110 in which the corresponding pipe would be disposed. More specifically, and as described below, the end face of the corresponding pipe would be flush with the front face 108 of the body 102 and extend through the opening 110 towards and beyond the rear face of the body 102. The body 102 has multiple holes 112 that pass through the body 102 from the front face 108 to the rear face. These holes 112 can be used to attach the flange 100 to a corresponding flange with corresponding holes using bolting. It should be appreciated that the number and size of the holes 112 can be varied according to the intended use and corresponding mechanical needs for securing the flanges together.

It should be appreciated that the dimensions of the body 102, including its outer diameter and circumference, length (as measured along the length of the corresponding pipe on which the body 102 is constructed), thickness (as measured from its interior surface 106 to its exterior surface 104), and inner diameter or circumference of the opening 110, may be determined based upon the corresponding size of the pipe upon which the flange 100 is constructed as well as the intended use of the flange 100. For example, the inner diameter of the body 102 forming the opening 110 will be equivalent to the outside diameter of the pipe onto which the flange 100 is constructed. The outer diameter of the front portion 104 may be adjusted as needed depending upon the specific application or use of the flange 100. The thickness can also be predetermined based upon the intended use of the flange 100 and any corresponding strength requirements, including the thickness necessary for the holes 110 and corresponding bolts that would be used to connect the flange 100 to another flange. It should be appreciated that the flange can be constructed in a manner to accommodate other means for joining or connecting the flange, including, for example, other means for mechanical clamping.

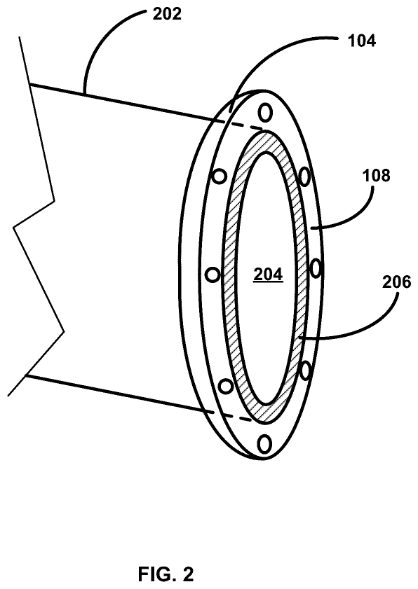

FIG. 2 is a perspective view of the flange of FIG. 1 on a section of a pipe according to one embodiment of the present invention. As shown, the flange 100 is located about the outer surface of a pipe 202 at one end of the pipe 202, with the pipe traversing through the opening 110 defined by the open cylinder of the flange body 102 (as shown in FIG. 1). The pipe 202 defines a circular opening 204 through which a fluid would pass during use of the pipe 202. It should be appreciated that the front face 108 of the body 102 of the flange 100 is flush with the end face 206 of the pipe 202. In other words, the cross-sectional face of the flange 100, specifically the front face 108, and the cross-sectional face 206 of the end of the pipe 202 are in, or are approximately in, the same plane. This facilitates the connection of the flange 100 and the pipe 202 with another flange and corresponding end of another pipe or other piece of equipment with a compatible flange.

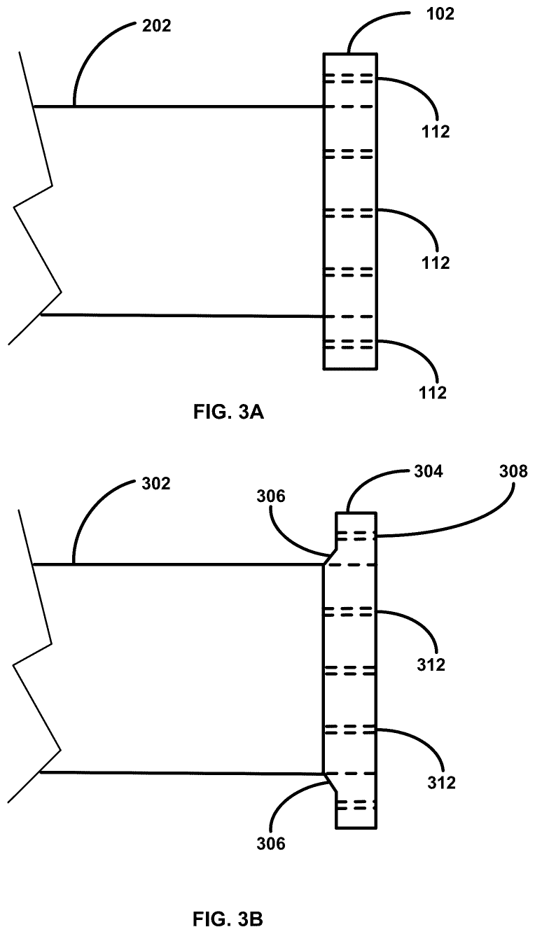

FIG. 3A is an elevational view of the longitudinal side of the flange and pipe of FIG. 2 according to one embodiment of the present invention. The pipe 202 is shown as extending through the body 102 of the flange 100. In addition, the holes 112 for use in bolting the flange 100 to another flange are also shown as traversing through the body 102 of the flange 100.

FIG. 3B is an elevational view of the longitudinal side of a flange and a pipe according to one embodiment of the present invention. Similar to FIG. 3A, a pipe 302 extends through the body 304 of the flange. However, in contrast to the flange of FIG. 3A, in this embodiment, the flange body 304 has a tapered portion 306 that extends from the outer surface of the pipe 302, with the remaining portion 308 of the flange body 304 extending perpendicular to the outer surface of the pipe 302. It should be appreciated that the tapered portion 306 provides for a reduction or elimination of any stress riser in the adjacent region of the pipe 302. It should be appreciated that the size of the tapered portion 306, including its height as measured vertically from the outer surface of the pipe 302 and its angle or distance along the sloped surface, can be adjusted as necessary to provide the desired reduction or elimination in stress riser. In some embodiments, the tapered portion may extend from 0-5 mm in height from the outer surface of the corresponding pipe. The holes 312 shown in the body 304 are the same as the holes 112 in FIG. 3A.

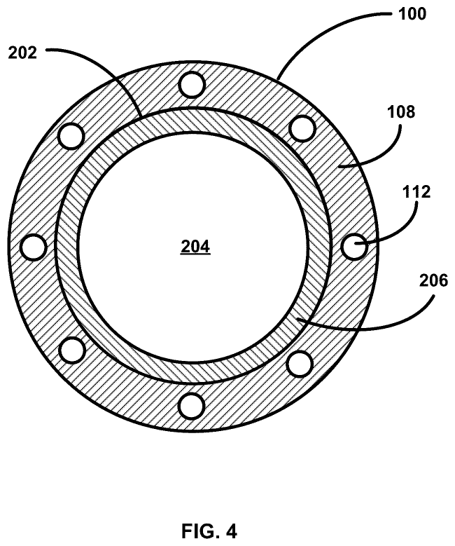

FIG. 4 is an elevational view of the end or cross-section of the flange and pipe of FIG. 2 according to one embodiment of the present invention. As shown, the flange 100 is located around the outside of the pipe 202, which has a thickness as determined by its use. The holes 112 used for bolting are also shown.

Turning to the process for fabricating the flange of the present invention, the flange is constructed or fabricated on the surface of a pipe on which the flange will be used. Additive manufacturing processes can be used to fabricate the flange on the pipe, specifically at an end of the pipe so as to facilitate connection to another flange. In some embodiments, the specific additive manufacturing processes that may be used include directed energy deposition and powder bed fusion. In some embodiments, other additive manufacturing processes may be used as well. It should be appreciated that fabrication of the flange of the present invention results in the construction of a flange having a single body attached at the desired location along a pipe as shown in FIGS. 1-4, which would typically be at the end of the pipe such that the face of the flange and the cross-section of the face of the pipe at its end are approximately flush with each other. It should also be appreciated that in connecting flanges to connect two pipe sections, in some embodiments, both flanges are fabricated using the present invention. It should be appreciated that the holes used for bolting a flange constructed by the process of the present invention can be made after fabrication of the flange on the pipe, for example, by drilling.

It should be appreciated that the use of power bed fusion may require changes to the typical equipment used and additional processing. The power bed fusion process employs a chamber (usually about the size of a kitchen microwave) wherein powder is successively built layer by layer until the appropriate height is achieved for the part being built, such as a flange. An argon or nitrogen environment is commonly employed to minimize the potential of oxidation. However, to build a flange onto the outer cylindrical surface at the end of a pipe section may require hardware modifications to the power bed fusion unit to accommodate the end of the pipe in the chamber, including rotating the pipe as the flange is constructed, and to maintain an argon or nitrogen environment. Additionally, a plugging device or method would be required within the pipe section to make sure that argon does not escape through the center of the pipe. One of skill in the art, however, can construct the chamber to accommodate these needs.

It should be appreciated that additive manufacturing, and specifically directed energy deposition and powder bed fusion, allow for the use of ODS and nickel-based alloys, in particular, precipitation strengthened nickel-based alloys, for the pipe on which the flange is constructed. By using additive manufacturing, the mechanical and metallurgical properties of the ODS or nickel-based alloy material can be retained after constructing the flange on the pipe such that the properties of the pipe (including its hoop strength) are not degraded at key stress regions, which may otherwise occur using other joining methods for attaching a flange to a pipe, such as welding. More specifically, the mechanical and metallurgical properties of the pipe, such as hardness, tensile strength, yield strength, fracture toughness, creep strength, and fatigue, and microstructure are not degraded throughout the pipe thickness and particularly at key stress regions resulting in retention of the strength of the ODS or nickel-based alloys, particularly along the hoop direction. In particular, such the mechanical and metallurgical properties of the pipe are not degraded compared to conventional welding methods used to attach a flange to the end of a pipe.

By building the flange around the outer periphery of the end of a pipe, local disruption in the distribution of oxides and the properties that may occur due to conventional joining are minimized or eliminated. In other words, the magnitude of penetration into the pipe by the additive manufacturing material used to construct the flange can be minimized, which allows for the mechanical and metallurgical properties of the pipe to remain substantively or fully retained.

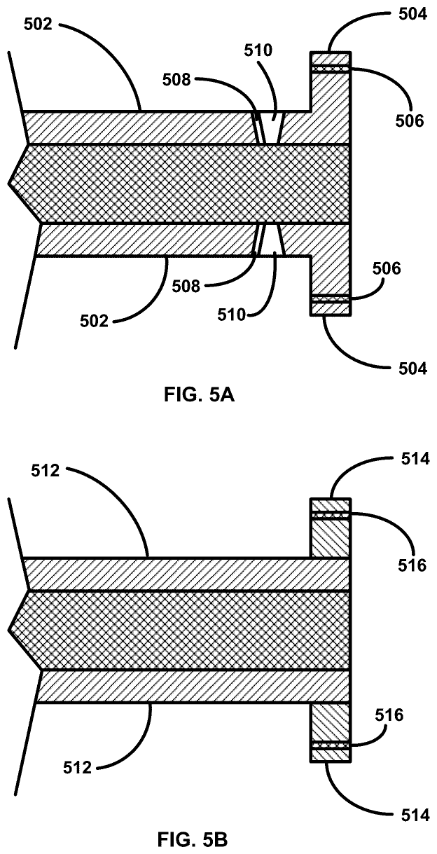

FIG. 5A illustrates a cross section of a pipe and flange welded to the pipe and the associated welding regions. As shown, a pipe 502 is welded to a flange 504 having an exemplary bolt hole 506. The flange 504 is welded to the end of the pipe 502 at the weld regions 508, 510. In particular, at the inner weld region 508, the mechanical and metallurgical properties of the pipe are degraded as a result of welding of the flange 504 to the pipe 502. In this case, the welding causes the microstructure of the pipe 502 to change throughout its entire thickness from inside the pipe 502 to the outside of the pipe 502. As a result, the mechanical and metallurgical properties, such as hardness, tensile strength, yield strength, fracture toughness, creep strength, and fatigue will be reduced across the throughwall thereby considerably reducing strength along the hoop direction.

FIG. 5B illustrates a cross-section of a pipe and flange attached to the pipe according to methods of the present invention. As shown, a pipe 512 has a flange 514 attached about its outer surface at one end having an exemplary bolt hole 516. In this particular embodiment, the flange 514 has been attached to the pipe 512 using additive manufacturing methods described above according to the present invention. As a result, there are no weld regions, such as those 508, 510 shown in connection with FIG. 5A, at which any mechanical or metallurgical properties of the pipe 512 have been degraded throughwall, which would otherwise be present had a flange been welded to the end of the pipe. Accordingly, building the flange 514 around the pipe 512 rather than attached it by welding, minimizes or avoids the creation of weld regions and related regions of stress that would otherwise degrade certain mechanical and metallurgical properties of the pipe 512. In the case of pipes made from ODS or nickel-based alloys, such degradation in the mechanical and metallurgical properties of the pipe may preclude its use in high temperature applications. Therefore, as described above, using the methods of the present invention to build the flange on a pipe constructed from ODS or nickel-based alloys minimizes or avoids such degradation and permits the use of such pipes in high temperature applications.

It should be appreciated that different additive manufacturing processes may also be used in combination to fabricate the flange on the end of a given pipe. For example, a portion of the flange could be fabricated on the pipe using powder bed fusion additive manufacturing to minimize the generation of excessive heat at the pipe surface, which may otherwise be present if, for example, directed energy deposition additive manufacturing is used. In this way, dilution at the pipe surface can be minimized while still providing a sufficient bond to the pipe surface. In other words, the magnitude of penetration into the pipe by the additive manufacturing material used to construct the flange can be minimized, which allows for the mechanical and metallurgical properties of the pipe to remain substantively or fully retained.

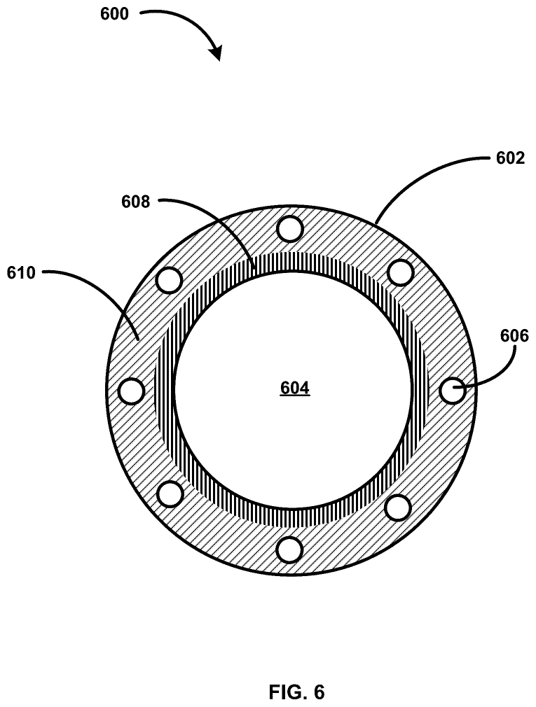

FIG. 6 is an elevational view of the end or cross-section of a flange according to one embodiment of the present invention. As shown, the flange 600 includes the body 602 of the flange 600. Similar to FIG. 1, the body 602 is an open cylinder that provides a circular opening 604 in which a corresponding pipe would be disposed. Also, similarly, the body 602 has multiple holes 606 that may be used for bolting.

As described above, the body 602 of the flange 600 is formed or constructed on the outer surface of a corresponding pipe. In this particular embodiment, the body 602 is formed using two different additive manufacturing processes. As shown an initial layer or portion 608 of the body 602 is formed on the outer surface of a corresponding pipe. The initial layer 608 is formed using one additive manufacturing process, such as power bed fusion. A second layer or portion 610 of the body 602 is then formed on top of the initial layer 608 to complete the formation or construction of the body 602 of the flange 600. In this embodiment, the second layer 610 is formed using a different or second additive manufacturing process, such as directed energy deposition. In some embodiments, the first or initial layer 608 may be approximately 5-10 mm in thickness (as measured from the outer surface of the corresponding pipe radially).

As described, the initial layer 608 may be constructed using powder bed fusion additive manufacturing, with the remainder of the flange constructed using directed energy deposition additive manufacturing, which can be used to deposit more material more quickly than powder bed fusion additive manufacturing. It should be appreciated that using the powder bed fusion additive manufacturing process to construct, for example, the first 1-2 mm of the initial or first layer 608 of the body 602, may reduce any effect to the microstructure of the corresponding underlying pipe at the interface between the outer surface of the pipe and the first layer 608 of the body 602 of the flange 600.

Turing to the materials of construction used to construct or fabricate the flange, it should be appreciated that the materials used in the additive manufacturing process to fabricate the flange may be similar or different from those of the pipe onto which the flange is constructed. Potential variations include the use of an ODS alloy to build the flange, which may be fabricated on a pipe having ODS alloys, or high temperature nickel-based alloy may be used to build the flange for use on a pipe having a different composition, such as an ODS alloy-based pipe. Since the pipe hoop strength, as well as other mechanical and metallurgical properties are maintained and not degraded via joining/welding, the use of similar or dissimilar materials for the flange should be successful.

In another embodiment, diode laser cladding may be used to generate the first 5-10 mm layer of the flange. In this case, additive manufacturing processes, such as directed energy deposition or powder bed fusion, may then be used to complete fabrication of the flange on the pipe.

Turning to use of the flange of the present invention, it should be appreciated that the flange constructed according to the present invention can be used in any piping application. It should be appreciated that the present invention allows for the fabrication of corresponding flanges at the ends of different pipe sections that are to be joined together, for example, through the use of bolts connecting the flanges or other means of clamping force. Accordingly, in some embodiments, flanges may be fabricated on the ends of different pipe sections, each pipe manufactured from ODS or nickel-based materials, that may then be connected.

In some embodiments, a flange on the surface of pipe constructed using additive manufacturing enables the use of ODS or nickel-based alloy (in particular, precipitation strengthened nickel-based alloys) materials in various high temperature piping applications. The present invention has particular use when using pipes having ODS or nickel-based alloys and for connecting pipe sections, each having corresponding ODS or nickel-based alloys.

In particular, the present invention and the flanges generated by the present invention have application in advanced energy systems, such as advanced nuclear (Gen IV) reactors, concentrated solar power, ultra-supercritical fossil power, sCO2 power cycles, and gas/hydrogen turbines. For example, in such systems, the flanges of the present invention may be used to connect pipe sections, including pipes constructed from ODS alloys, or to construct a flange according to the present invention on other piping components or equipment, such as a valve, pump, heat exchanger and other similar components.

Various embodiments of the invention have been described above. However, it should be appreciated that alternative embodiments are possible and that the invention is not limited to the specific embodiments described above. For example, the methods of the present invention may be used to fabricate a flange on a piping component made from other than ODS or nickel-based alloys. The flange as constructed by the present invention may also be used in other than high-temperature applications. It should be appreciated that other additive manufacturing processes may be used provided the microstructure and mechanical properties of the flange are not significantly degraded.

What is claimed is:

1. A method for constructing a flange on a pipe, comprising:
using an additive manufacturing process to build a flange on an outer surface of a pipe at a first end of the pipe.

2. The method of claim 1, wherein the pipe retains mechanical properties compared to welding a flange onto the pipe.

3. The method of claim 2, wherein the mechanical properties are selected from the group consisting of hardness, tensile strength, yield strength, fracture toughness, creep strength, fatigue, and combinations thereof.

4. The method of claim 1, wherein the pipe retains its microstructure compared to welding a flange onto the pipe.

5. The method of claim 1, wherein the pipe comprises an oxide dispersion strengthen alloy.

6. The method of claim 1, wherein the pipe comprises a nickel-based alloy.

7. The method of claim 6, wherein the nickel-based alloy comprises a precipitation strengthened nickel-based alloy.

8. The method of claim 1, wherein the additive manufacturing process is selected from the group consisting of directed energy deposition, powder bed fusion, friction stir, diode laser cladding, and combinations thereof.

9. The method of claim 1, wherein said using comprises:
using powder bed fusion to construct the first 5-10 mm of the flange on the outer surface of the pipe; and
using directed energy deposition to construct the remainder of the flange.

10. The method of claim 1, wherein said using comprises:
using diode laser cladding to construct the first 5-10 mm of the flange on the outer surface of the pipe; and
using directed energy deposition to construct the remainder of the flange.

11. A pipe and flange, comprising:
a pipe having a first end comprising an exposed cross-sectional surface and an outer cylindrical surface; and
a flange attached to the pipe on the outer cylindrical surface at the first end such that the cross-sectional surface of the pipe is exposed;
wherein said flange comprises an additive manufactured flange.

11. The pipe and flange of claim 11, wherein said pipe comprises an oxide dispersion strengthen alloy.

12. The pipe and flange of claim 11, wherein said pipe comprises a nickel-based alloy.

13. The pipe and flange of claim 12, wherein the nickel-based alloy comprises a precipitation strengthened nickel-based alloy.

14. The pipe and flange of claim 11, wherein said pipe comprises a hoop strength that is the same or lower than a hoop strength of a pipe having a flange manufactured by a method different from said additive manufactured flange.

15. The pipe and flange of claim 11, wherein the pipe wherein the pipe retains mechanical properties compared to welding a flange onto the pipe.

16. The method of claim 15, wherein the mechanical properties are selected from the group consisting of hardness, tensile strength, yield strength, fracture toughness, creep strength, fatigue, and combinations thereof.

17. The method of claim 11 wherein the pipe retains its microstructure compared to welding a flange onto the pipe.
